(19) United States
(12) Patent Application Publication
(10) Pub. No.: US 2024/0002221 A1
(43) Pub. Date: Jan. 4, 2024

(54) A METHOD FOR PRODUCING SYNGAS USING CATALYTIC REVERSE WATER GAS SHIFT

(71) Applicant: SHELL OIL COMPANY, Houston, TX (US)

(72) Inventors: Ronald Jan SCHOONEBEEK, Amsterdam (NL); Alouisius Nicolaas Renée BOS, Amsterdam (NL); Dominik Johannes Michael UNRUH, Amsterdam (NL); Dennis Patrick VAN DER SLOOT, Amsterdam (NL)

(21) Appl. No.: 18/254,230

(22) PCT Filed: Dec. 16, 2021
(86) PCT No.: PCT/EP2021/086210

§ 371 Date: May 24, 2023

(30) Foreign Application Priority Data
Dec. 18, 2020 (EP) 20215370.6

(51) Int. Cl. C01B 3/02; C01B 32/40

(52) U.S. Cl. CPC C01B 3/02; C01B 32/40; C01B 2203/0288; C01B 2203/0495; C01B 2203/1205; C01B 2203/0833

(57) ABSTRACT

A method for producing syngas that comprises providing a feed stream comprising H₂ and CO₂; heating the feed stream in a first heat exchanger to obtain a first heated feed stream; introducing the first heated feed stream into a first RWGS reactor to obtain a first syngas containing stream; cooling the first syngas containing stream in the first heat exchanger against the feed stream to obtain a first cooled syngas stream; separating the first cooled syngas stream in a first gas/liquid separator to obtain a water-enriched stream and a water-depleted syngas stream; heating the water-depleted syngas stream in a second heat exchanger to obtain a heated water-depleted syngas stream; introducing the heated water-depleted syngas stream into a second RWGS reactor to obtain a second syngas containing stream; and cooling the second syngas containing stream in the second heat exchanger against the water-depleted syngas to obtain a cooled syngas product stream.

The present invention relates to a method for producing syngas using a catalytic reverse water gas shift (RWGS) reaction.

Methods for producing syngas using RWGS are known. RWGS reactions convert carbon dioxide (CO₂) and hydrogen (H₂) into ‘syngas’, which contains at least carbon monoxide (CO) and hydrogen (H₂), and typically also water (H₂O) and unconverted carbon dioxide (CO₂). RWGS reactions are endothermic in nature; hence, it is necessary to supply sufficient thermal energy to the reactants (i.e. carbon dioxide and hydrogen) to facilitate the endothermic RWGS reaction.

The RWGS reaction is in fact the backward reaction of the equilibrium of the ‘water gas shift’ (WGS) reaction, which is a well-known reaction to convert carbon monoxide and water to carbon dioxide and hydrogen. The RWGS reaction can proceed without the use of a catalyst, but this requires very high temperatures (e.g. 1000° C. or even much higher) favoring both the kinetics and maximum achievable equilibrium conversions.

If a catalyst for the RWGS reaction is used, much lower temperatures may be required for the reaction to proceed and the reaction conditions and catalyst used are to be selected such that the catalyzation of the very exothermic methanation reaction (CO₂+4H₂→CH₄+2H₂O) is avoided or at least minimized. The thermodynamics may drive the reaction towards methanation and too low temperatures may severely limit the equilibrium conversion RWGS itself, so finding reaction conditions and catalyst resulting in acceptable conversion of CO₂ to syngas with non-methanation or very low methanation is a key challenge.

Currently, the status of developments regarding the RWGS reaction have been mostly on lab-scale. There is still a lot to explore until large-scale RWGS will be a commercially attractive option.

For large-scale conversion of carbon dioxide there is a need to be able to more efficiently and economically carry out the RWGS reaction. In achieving high conversion of carbon dioxide selectively to carbon monoxide, by-products like methane and carbon formation are to be avoided. Also, the amount of energy input required for performing the endothermic RWGS reaction requires attention.

As a mere example of a recently published RWGS method, WO2020114899A1 discloses a method for producing syngas using a RWGS reaction, wherein no catalyst is present in the reaction vessel and the temperature in the reaction vessel is maintained in the range of 1000 to 1500° C.

A problem of the above method is that relatively high temperatures are used to perform the RWGS reaction which requires the use of high temperature resistant materials in the reaction vessel, synthesis gas coolers or feed effluent heat exchangers.

Another problem of the above method is that a relatively high energy input is required to perform the (endothermic) RWGS reaction and to heat up the feed stream to the reaction temperature.

Another example of a published method is disclosed in Meiri Nora et al.; “Simulation of novel process of CO2 conversion to liquid fuels”; Journal of CO2 Utilization, 2 Jan. 2017 (2017-01-02), pages 284-289, XP0555806845, DOI: http://dx.doi.org/10.1016/j.jcou.2016.12.008. Meiri discloses a process that produces a liquid fuel directly from a mixture of H₂ and CO₂ directly. In Meiri, different from the present invention, most of the CO₂ and H₂ (50-65%) are converted within each of their reactors to mostly C5+ liquid hydrocarbons. As shown in Meiri, the liquid streams from the 3 separators are hydrocarbons with water and each of the 3 reactors partially convert the H₂/CO₂ feed to liquid hydrocarbons, with an inevitable by-product water from the in-situ conversion of the syngas to desired relatively long chain hydrocarbon liquids via H₂+CO→(CH₂)ₙ+H₂O.

Meiri also discloses a reactor operating temperature (dictated by requirements of the Fischer-Tropsch synthesis) of around 300 degrees C. and use of an iron catalyst. As such, the process in Meiri produces more undesired methane and more of other <C5+ paraffins that are less desirable.

Other example processes are provided in Andreas Wolf et al.; “Syngas Production via Reverse Water-Gas Shift Reaction over a Ni—Al2 O3 Catalyst: Catalyst Stability, Reaction, Kinectics, and Modeling”; Chemical Engineering Technology, vol. 39, no. 6, 29 Jun. 2016 (2016-06-29), pages 1040-1048, XP055297640 and Lee Sunggeun et al.; “The power of molten salt in methane dry reforming: Conceptual design with a CFD study”; Chemical Engineering and Processing: Process Intensification, Elsevier Sequoia, Lausanne, CH, vol. 159, 16 Nov. 2020 (2020-11-16), XP086454012. However, Andreas discloses different methanating metal catalysts and a process line-up different from the present invention. Lee discloses molten-salt heated multi-tubular reactors for a refining process and not RWGS as in the present invention.

It is an object of the present invention to minimize one or more of the above problems, i.e. methanation, equipment material problems and high energy input at high temperatures, low conversion to high quality syngas at low temperatures. It is an object of the present invention to provide a process wherein the product is syngas (a mixture of H₂ and CO) suitable for a variety of subsequent conversion processes (e.g. methanol synthesis and Cobalt based Fischer-Tropsch synthesis). Further, in the present invention >99% of the converted CO₂ is converted to CO and virtually no conversion to methane or any other hydrocarbons.

It is a further object of the present invention to provide a method for producing syngas using a RWGS reaction that can be performed at lower temperatures, preferably lower than 700° C.

One or more of the above or other objects can be achieved by providing a method for producing syngas using a catalytic reverse water gas shift (RWGS) reaction, the method at least comprising the steps of:
a) providing a feed stream comprising at least hydrogen (H₂) and carbon dioxide (CO₂);
b) heating the feed stream provided in step a) in a first heat exchanger thereby obtaining a first heated feed stream;
c) introducing the first heated feed stream into a first RWGS reactor and subjecting it to a first catalytic RWGS reaction, thereby obtaining a first syngas containing stream;
d) removing the first syngas containing stream obtained in step c) from the first RWGS reactor;
e) cooling the first syngas containing stream removed from the first RWGS reactor in step d) in the first heat exchanger against the feed stream provided in step a), thereby obtaining a first cooled syngas stream;
f) separating the first cooled syngas stream obtained in step e) in a first gas/liquid separator thereby obtaining a water-enriched stream and a water-depleted syngas stream;
g) heating the water-depleted syngas stream obtained in step f) in a second heat exchanger thereby obtaining a heated water-depleted syngas stream;
h) introducing the heated water-depleted syngas stream obtained in step g) into a second RWGS reactor and subjecting it to a second catalytic RWGS reaction, thereby obtaining a second syngas containing stream;
i) removing the second syngas containing stream obtained in step h) from the second RWGS reactor; and
j) cooling the second syngas containing stream removed from the second RWGS reactor in step i) in the second heat exchanger against the water-depleted syngas stream obtained in step f), thereby obtaining a cooled syngas product stream.

It has surprisingly been found according to the present invention that even though the RWGS reaction is performed at relatively low temperatures (such as below 700° C.), a desirable conversion of CO₂ of above 65% or even above 70% may be achieved. Also, methanation (methane formation) and coke formation is minimized.

An important advantage of the present invention is that less expensive materials need to be used for e.g. the reactors in view of the lower temperatures being used.

Also, commercially available heated reactors (e.g. using molten salt or multi-tubular molten salt reactors can be used for the heating required in the endothermic RWGS reaction.

A further advantage of the present invention is that it allows for flexibility in the CO/H₂ ratio of the obtained syngas product stream. Dependent on the use of the syngas product stream (such as production of methanol, use in Fischer-Tropsch reaction, etc.), the CO/H₂ ratio can be easily adapted.

In step a) of the method according to the present invention a feed stream is provided comprising at least hydrogen (H₂) and carbon dioxide (CO₂).

The person skilled in the art will readily understand that the feed stream is not particularly limited and may come from various sources. Typically, the feed stream comprises 60-80 vol. % H₂, preferably 65-75 vol. % H₂, and typically 20-40 vol. % CO₂, preferably 25-35 vol. % CO₂. Other components such as H₂, CH₄, CO, H₂O, C2+, C=2+, N₂, Ar, O₂ and sulphur components (H₂S, mercaptans, COS, SO₂) may be present.

Generally, the feed stream has a hydrogen to carbon dioxide (H₂/CO₂) volume ratio of from 1 to 5, preferably between 2 and 3.5. The H₂/CO₂ volume ratio of hydrogen to carbon dioxide is adjusted such that the required hydrogen to carbon monoxide ratio in the eventual product stream is obtained.

Generally, the feed stream has a temperature of 5-150° C. and, preferably above 20° C. The feed stream typically has a pressure in the range of from 0.5 to 200 bara. Preferably, the pressure is from 5 to 70 bara.

In step b) of the method according to the present invention, the feed stream provided in step a) is heated (by indirect heat exchange) in a first heat exchanger thereby obtaining a first heated feed stream.

Typically, the first heated feed stream has a temperature of 200-700° C., preferably 450-600° C. The person skilled in the art will readily understand that in addition to the first heat exchanger, further heat exchangers may be present; such further heat exchangers may form part of the overhead of the first RWGS reactor.

In step c) of the method according to the present invention, the first heated feed stream is introduced into a first RWGS reactor and subjecting it to a first catalytic RWGS reaction, thereby obtaining a first syngas containing stream.

As the person skilled in the art is familiar with RWGS reactors and conditions of catalytic RWGS reactions, this is not discussed here in detail.

Typical temperatures of the catalytic RWGS reaction in the first RWGS reactor are 450-700° C., preferably above 500° C. The person skilled in the art will understand that the temperature may vary over the reactor (e.g. higher at the inlet than at the outlet, in particular for an adiabatic process). Preferably, the temperature of the first catalytic RWGS reaction in step c) is kept below 700° C., preferably below 600° C.

As, the RWGS reaction is endothermic, heating needs to be provided to the reactor. This heating may come from any source, e.g. indirectly via heating by molten salt circulating around the individual tubes of a multi-tubular reactor wherein the circulating molten salt itself is heated by electrical heating, preferably in counter-current mode, or directly via the feed stream in the case of an adiabatic process.

Typical pressures as used in the first (and other) RWGS reactor(s) are 1-200 bara, preferably 20-60 bara. Further, typical gas hourly space velocities (GHSV) are 1000-100,000 h⁻¹, preferably above 5,000 h⁻¹ and preferably below 20,000 h⁻¹.

In the first RWGS reactor a catalytic RWGS reaction takes place and this requires the presence of a catalyst. Typically, the first RWGS reactor contains a catalyst bed. As the person skilled in the art is familiar with suitable RWGS beds and catalysts, this is not discussed here in detail. Preferably, the catalyst bed comprises a catalyst that is suitable for performing a RWGS reaction below 700° C. Further it is preferred that the catalyst does not promote methanation under the used conditions. Preferred examples of suitable ‘non-methanation promoting’ catalysts comprise at least cerium oxide, zirconium oxide, or a combination thereof. The catalyst may contain further components in addition to the cerium oxide and/or zirconium oxide.

According to a preferred embodiment of the present invention, at least one of the first and the second RWGS reactors (to be discussed later) contains two or more catalyst beds with additional intermediate heating between the two or more catalyst beds. The two or more catalyst beds within the same RWGS reactor may contain the same or different catalysts.

According to a further preferred embodiment, at least one of the first and the second RWGS reactors comprises a multi-tubular reactor heated by molten salt circulating around the tubes of the multi-tubular reactor. In this embodiment, the molten salt provides for the heat required for the endothermic reaction as taking place in the multi-tubular reactor. Preferably, the molten salt is circulating in counter-current mode around the tubes of the multi-tubular reactor (when compared to the fluid flow in the tubes of the reactor). The circulating molten salt is preferably heated from outside the reactor.

Preferably, each of the tubes of the multi-tubular reactor comprises a catalyst.

As a result of the first RWGS reaction in step c), a first syngas containing stream is obtained, at least comprising hydrogen (H₂) and carbon monoxide (CO).

Typically, the first syngas containing stream also contains water (H₂O) and unconverted carbon dioxide (CO₂). Typically, the amounts of components in the first syngas containing stream are around thermodynamic equilibrium concentrations.

Generally, the first syngas containing stream has a hydrogen to carbon monoxide (H₂/CO) volume ratio in the range of 0.5 to 5, preferably in the range of 1.5 to 3.

One of the advantages of the present invention is that the used RWGS reaction results in low methanation (methane formation). Preferably, the first syngas containing stream comprises at most 1.0 vol. % methane (CH₄), preferably at most 0.1 vol. % methane.

In step d) of the method according to the present invention, the first syngas containing stream obtained in step c) is removed from the first RWGS reactor.

In step e) of the method according to the present invention, the first syngas containing stream removed from the first RWGS reactor in step d) is cooled in the first heat exchanger against the feed stream provided in step a), thereby obtaining a first cooled syngas stream.

Typically, the first cooled syngas stream has a temperature of 80-250° C. and, preferably below 200° C.

In step f) of the method according to the present invention, the first cooled syngas stream obtained in step e) is separated in a first gas/liquid separator thereby obtaining a water-enriched stream and a water-depleted syngas stream.

Typically, the amounts of components in the water-depleted syngas stream are around thermodynamic equilibrium concentrations.

In step g) of the method according to the present invention, the water-depleted syngas stream obtained in step f) is heated in a second heat exchanger thereby obtaining a heated water-depleted syngas stream.

The person skilled in the art will understand that further heat exchangers may be present. These further heat exchangers may also be part of the RWGS reactor. Also, these further heat exchangers may be heated by electrical heating.

Typically, the heated water-depleted syngas stream has a temperature of 450-700° C. and, preferably 500-600° C.

In step h) of the method according to the present invention, the heated water-depleted syngas stream obtained in step g) is introduced into a second RWGS reactor and is subjected to a second catalytic RWGS reaction, thereby obtaining a second syngas containing stream.

Typically, the temperatures and other conditions of the second RWGS reactor will typically be the same as, or similar to, the temperatures and other conditions of the first RWGS reaction as described above.

Generally, the heated water-depleted syngas stream introduced into the second RWGS reactor has a hydrogen to carbon dioxide (H₂/CO₂) volume ratio of from 1 to 5, preferably between 2 and 3.5. The H₂/CO₂ volume ratio of hydrogen to carbon dioxide is adjusted such that the required hydrogen to carbon monoxide ratio in the eventual product stream is obtained.

As mentioned above, the temperatures and other conditions of the second RWGS reactor will typically be the same as, or similar to, the temperatures and other conditions of the first RWGS reactor as described above. Hence, typical temperatures of the catalytic RWGS reaction in the first RWGS reactor are 450-700° C., preferably above 500° C. Preferably, the temperature of the second catalytic RWGS reaction in step c) is kept below 700° C., preferably below 600° C.

Similar to the first RWGS reactor, the second RWGS reactor also typically contains a catalyst bed. It is also preferred that the catalyst bed comprises a catalyst that is suitable for performing a RWGS reaction below 700° C.

The second RWGS reactor may contains two or more catalyst beds with additional intermediate heating between the two or more catalyst beds.

As a result of the second RWGS reaction in step h), a second syngas containing stream is obtained, at least comprising hydrogen (H₂) and carbon monoxide (CO). Typically, the second syngas containing stream also contains water (H₂O) and unconverted carbon dioxide (CO₂). Typically, the amounts of components in the second syngas containing stream are around thermodynamic equilibrium concentrations.

Generally, the second syngas containing stream has a hydrogen to carbon monoxide (H₂/CO) volume ratio in the range of 1.5 to 5, preferably in the range of 1.8 to 2.5.

One of the advantages of the present invention is that the used RWGS method results in low methanation (methane formation). Preferably, the second syngas containing stream comprises at most 1.0 vol. % methane (CH₄), preferably at most 0.2 vol. % methane.

In step i) of the method according to the present invention, the second syngas containing stream obtained in step h) is removed from the second RWGS reactor.

In step j) of the method according to the present invention, the second syngas containing stream removed from the second RWGS reactor in step i) is cooled in the second heat exchanger against the water-depleted syngas stream obtained in step f), thereby obtaining a cooled syngas product stream.

Typically, the cooled syngas product stream has a temperature of 80-250° C. and, preferably 100-200° C. This stream may be further cooled to ambient.

Preferably, the method further comprises the step of separating the cooled syngas product stream obtained in step j) in a second gas/liquid separator, thereby obtaining a water-enriched stream and a water-depleted syngas product stream.

The person skilled in the art will understand that the method according to the present invention may comprise further processing steps, including further RWGS reactors and g/l separators. Also, such further RWGS reactors may also contain two or more catalyst beds, with intermediate heating.

According to an especially preferred embodiment, the steps of separating (as in step f), for water removal), heating (as in step g)) and introducing/subjecting to catalytic RWGS reaction (as in step h)) are repeated at least 1, at least 2 or even more times, resulting in the presence of 3, 4 or even more RWGS reactors in series. The temperatures and other conditions of the further RWGS reactors will typically be the same as, or similar to, the temperatures and other conditions of the first and second RWGS reactors as described above. Preferably, the temperature of the further RWGS reactors is kept below 700° C., preferably below 600° C.

In a further aspect, the present invention provides an apparatus suitable for performing the method for producing syngas according to the present invention, the apparatus at least comprising:
a first heat exchanger for heat exchanging the feed stream against the first syngas containing stream removed from the first RWGS reactor, to obtain a first heated feed stream and a first cooled syngas stream;
a first RWGS reactor to obtain a first syngas containing stream;
a first gas/liquid separator for separating the first cooled syngas stream to obtain a water-enriched stream and a water-depleted syngas stream;
a second heat exchanger for heat exchanging the water-depleted syngas and the second syngas containing stream removed from the second RWGS reactor, to obtain a heated water-depleted syngas stream and a cooled syngas product stream;
a second RWGS reactor to obtain a second syngas containing stream.

Preferably, at least one of the first and the second RWGS reactors contains two or more catalyst beds with additional intermediate heating between the two or more catalyst beds.

Further it is preferred that the apparatus further comprising a second gas/liquid separator for separating the cooled syngas product stream to obtain a water-enriched stream and a water-depleted syngas product stream.

Alternatively, or additionally, and as mentioned above, it is preferred that at least one of the first and the second RWGS reactors comprises a multi-tubular reactor heated by a molten salt circulating around the tubes of the multi-tubular reactor.

Hereinafter the present invention will be further illustrated by the following non-limiting drawings. Herein shows:

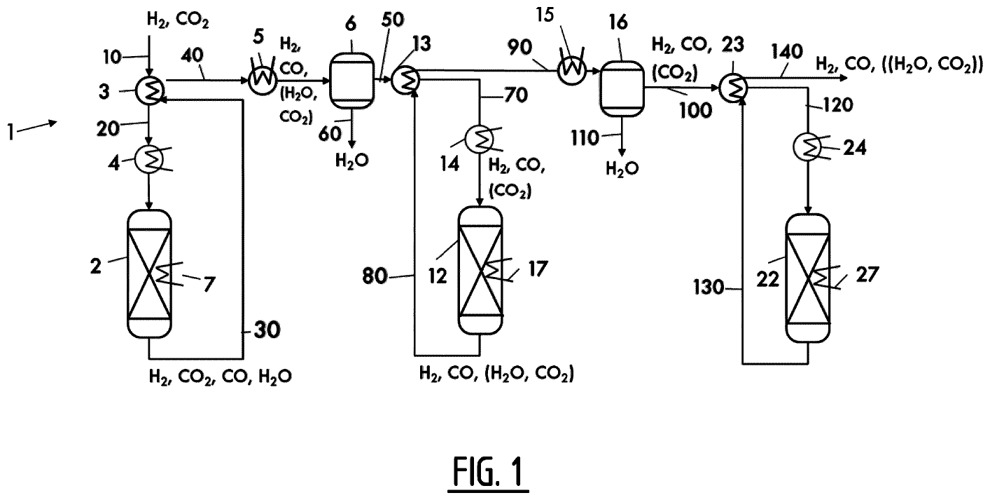

FIG. 1 schematically a first embodiment of an apparatus suitable for performing the method for producing syngas using a catalytic RWGS reaction according to the present invention; and

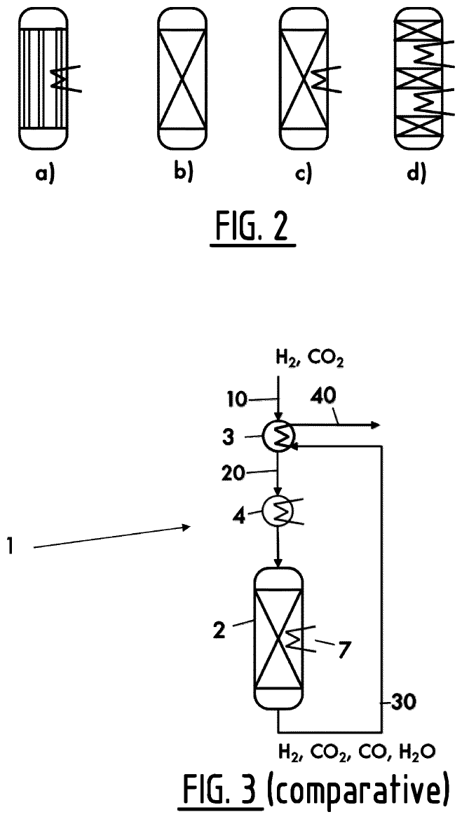

FIG. 2 schematically examples of different reactor types that can be used for the RWGS reactors as used according to the present invention; and

FIG. 3 schematically an example of an apparatus with a single RWGS reactor (included for comparative purposes).

For the purpose of this description, same reference numbers refer to same or similar components.

The apparatus of FIG. 1, generally referred to with reference number 1, comprises a first RWGS reactor 2, a second RWGS reactor 12 and a third RWGS reactor 22; a first heat exchanger 3, a second heat exchanger 13 and a third heat exchanger 23; further heat exchangers 4, 5, 14, 15 and 24; and a first gas/liquid separator 6 and a second gas/liquid separator 16.

Each of the RWGS reactors 2, 12 and 22 comprise a catalyst bed and is provided with external heating 7, 17, 27 (e.g. in the form of electrical heating or molten salt heater).

During use, a feed stream 10 is provided, which feed stream comprises at least hydrogen (H₂) and carbon dioxide (CO₂).

The feed stream is heated in the first heat exchanger 3 thereby obtaining a first heated feed stream 20. As shown in the embodiment of FIG. 1, the heated feed stream 20 may be further heated in a further heat exchanger 4. This further heat exchanger 4 may form part of the first RWGS reactor 2.

The first heated feed stream 20 is introduced into the first RWGS reactor 2 and subjected to a first catalytic RWGS reaction, thereby obtaining a first syngas containing stream, which is removed as stream 30 from the first RWGS reactor 2.

Then, the first syngas containing stream 30 is cooled in the first heat exchanger 3 by indirect heat exchange against the feed stream 10, thereby obtaining a first cooled syngas stream 40. As shown in the embodiment of FIG. 1, the cooled syngas stream 40 may be further cooled in the further heat exchanger 5.

Subsequently, the first cooled syngas stream 40 is separated in the first gas/liquid separator 6 thereby obtaining a water-enriched stream 60 and a water-depleted syngas stream 50.

The water-depleted syngas stream 50 is then heated in the second heat exchanger 13 thereby obtaining a heated water-depleted syngas stream 70. This heated water-depleted syngas stream 70 is then introduced into the second RWGS reactor 12 and subjected to a second catalytic RWGS reaction, thereby obtaining a second syngas containing stream which is removed from the second RWGS reactor 12 as stream 80.

This second syngas containing stream 80 is cooled in the second heat exchanger 13 by indirect heat exchange against the water-depleted syngas stream 50, thereby obtaining a cooled syngas product stream 90.

In the embodiment of FIG. 1, this cooled syngas product stream 90 is subjected to another round of separating (in gas/liquid separator 16), heating (in third heat exchanger 23), RWGS reaction (in third RWGS reactor 22) and cooling (in third heat exchanger 23), to obtain the final product stream 140.

The heat exchangers 4, 14 and 24 may be integrated with the external heating 7, 17 and 27.

FIG. 2 shows schematically non-limiting examples of different reactor types that can be used for the RWGS reactors in the apparatus 1 according to the present invention. The apparatus may comprise different types of reactors.

The reactor of FIG. 2a) comprises a multi-tubular reactor heated by a molten salt circulating around the tubes of the multi-tubular reactor. Preferably, the molten salt flow inside the shell of the multi-tubular reactor is counter-currently when compared to the flow of the gas inside the tubes. As shown, the molten salt may be heated by separate external heating, preferably an e-heater. If molten salt is used for two or more reactors, then there may be a common circuit for the molten salt.

The reactor of FIG. 2b) comprises a single catalyst bed, whilst the reactor of FIG. 2c) comprises a single catalyst bed provided with external heating. In FIG. 1 the reactors of the type shown in FIG. 2c) are used.

Further, the reactor of FIG. 2d comprises 3 catalyst beds with intermediate external heating between the beds.

Generally, if any of the reactors of 2b)-d) is used, then preheating (as in heat exchangers 4, 14, 24) is required.

FIG. 3 shows an example of an apparatus with a single RWGS reactor. FIG. 3 is not according to the present invention, but included for comparative purposes.

### EXAMPLES

### Example 1

The apparatus of FIG. 1 was used for illustrating an exemplary method according to the present invention. The compositions and conditions of the streams in the various flow lines are provided in Table 1 below.

The values in Table 1 were calculated using a model generated with commercially available UniSim software, whilst using an ‘equilibrium reactor’ with settings such that only the (R)WGS reactions are allowed to occur and whilst arranging the settings such that no methanation occurred (hence 0 vol % CH₄ in all streams). Thus, the standard ‘Gibbs model’ was not used, which model would predict excess methanation (which does not occur or is at least minimized according to the present invention).

TABLE 1

| stream | 10 | 20 | 30 | 40 | 50 | 60 | 70 | 80 | 90 | 100 | 110 | 120 | 130 | 140 |
|---|---|---|---|---|---|---|---|---|---|---|---|---|---|---|
| T [° C.] | 65 | 450 | 550 | 160 | 40 | 40 | 450 | 550 | 140 | 40 | 40 | 450 | 550 | 140 |
| CO₂ | 30 | 30 | 15 | 15 | 18 | 0 | 18 | 11 | 11 | 12 | 0 | 11 | 8 | 8 |
| [vol. %] | | | | | | | | | | | | | | |
| H₂ | 70 | 70 | 54 | 54 | 64 | 0 | 64 | 57 | 57 | 61 | 0 | 62 | 58 | 58 |
| [vol. %] | | | | | | | | | | | | | | |
| CO | 0 | 0 | 15 | 15 | 18 | 0 | 18 | 25 | 25 | 27 | 0 | 27 | 31 | 31 |
| [vol. %] | | | | | | | | | | | | | | |
| H₂O | 0-10 | 0-10 | 15 | 15 | 0 | 100 | 0 | 7 | 7 | 0 | 100 | 0 | 4 | 4 |
| [vol. %] | | | | | | | | | | | | | | |
| H₂O/CO₂ | 2.3 | | | | | | | | | | | | | |
| H₂O/CO | — | — | 3.6 | 3.6 | 3.6 | — | 3.6 | 2.3 | 2.3 | 2.3 | — | 2.3 | 1.9 | 1.9 |
| XCO₂¹ | — | — | — | 50.6 | 50.6 | — | — | — | 70.0 | 70.0 | — | — | — | 80.2 |

¹XCO₂ = conversion of CO₂, based on feed stream 10.

### Example 2 (Comparative)

For comparison with FIG. 1, two sets of calculations were performed for the line-up of FIG. 3 whilst using the same UniSim software as used in Example 1.

Table 2A shows the compositions and conditions of the streams in the various flow lines whilst performing the RWGS reaction in the reactor 2 at lower temperature (˜550° C.; comparable with Example 1) and Table 2B the same at higher temperatures (˜1100° C.).

TABLE 2A

| stream | 10 | 20 | 30 | 40 |
|---|---|---|---|---|
| T [° C.] | 65 | 450 | 550 | 160 |
| CO₂ | 30 | 30 | 15 | 15 |
| [vol. %] | | | | |
| H₂ | 70 | 70 | 55 | 55 |
| [vol. %] | | | | |
| CO | 0 | 0 | 15 | 15 |
| [vol. %] | | | | |
| H₂O | 0-10 | 10 | 15 | 15 |
| [vol. %] | | | | |
| H₂O/CO₂ | 2.3 | | | |
| H₂O/CO | — | — | 3.6 | 3.6 |
| XCO₂ | — | — | — | 50.6 |

TABLE 2B

| stream | 10 | 20 | 30 | 40 |
|---|---|---|---|---|
| T [° C.] | 65 | 950 | 1100 | 190 |
| CO₂ | 30 | 30 | 6 | 6 |
| [vol. %] | | | | |
| H₂ | 70 | 70 | 45 | 45 |
| [vol. %] | | | | |
| CO | 0 | 0 | 24 | 24 |
| [vol. %] | | | | |
| H₂O | 0-10 | 10 | 24 | 24 |
| [vol. %] | | | | |
| H₂O/CO₂ | 2.3 | | | |
| H₂O/CO | — | — | | 1.9 |
| XCO₂ | — | — | — | 80.0 |

As can be seen from Table 2A, the line-up of FIG. 3 with only one RWGS reactor resulted in a relatively low CO₂ conversion (50.6%) when operated at about 550° C.

As can be seen from Table 2B, when the same line-up of FIG. 3 was operated at higher temperature (at about 1100° C.) a desirable CO₂ conversion (80%) was obtained.

### Example 3

A microflow reactor was used to experimentally test the high overall conversion of CO₂ by operating catalytic RWGS in two (or more) stages with intermediate removal of H₂O, at relatively low temperatures, mimicking the line-up of FIG. 1.

In the microflow reactor 1.05 gram of a 30-80 mesh sieve fraction CeO₂/ZrO₂ catalyst (Actalys; obtainable from Solvay) was loaded in a 48 cm long Aluminide-coated Alloy 800 reactor tube with an internal diameter of 3.0 mm, obtainable from Diffusion Alloys Limited (UK).

The catalyst bed had a height of 5 cm and was located in the isothermal zone of the reactor by means of an internal inert Al₂O₃ rod with a length of 15 cm and an outer diameter of 2.2 mm. The rod itself was kept in place by a plug of quartz wool located at the cold bottom part of the reactor. The reactor was placed in an electrically heated oven.

With the use of thermal mass flow controllers (obtainable from Brooks (Veenendaal, the Netherlands)) calibrated gas flows, were passed in down-flow over the catalyst bed at a pressure of 10.6 bara. The nitrogen flow rate was 0.5 Nl/h and was used as an internal standard. After water condensation, the dry product composition was measured with an online micro-GC (Interscience (Breda, NL)). By using nitrogen as internal standard, the CO₂ conversion was calculated.

The catalyst showed very stable performance at the applied conditions and hardly any methane formation was observed. In all experiments the gas composition was essentially equal to the calculated RWGS thermodynamic equilibrium composition, provided for the latter the methanation reaction is excluded from that calculation.

In Example 3A the conditions were selected to represent the first stage RWGS reactor of FIG. 1.

Table 3 below shows the results of this Example 3A. From Table 3, it can be seen that the measured CO₂ conversion matches exactly the conversion predicted by thermodynamics, provided the formation of methane is assumed not to take place at all. Note that thermodynamically methane will be formed in high amounts at the conditions of the experiments, at >90% selectivity.

In Example 3B, the CO/H₂ outlet ratio of Example 3A was used as inlet composition, albeit not exactly, i.e. at a bit too high CO/H₂. This simulates the second stage RWGS reactor of FIG. 1. The GHSV was adapted accordingly, i.e. lowered to represent the reduction in total flow to this second stage RWGS reactor of FIG. 1 due to removal of H₂O.

In Example 3C, Example 3B was repeated but with an inlet CO/H₂ ratio closer to the outlet of Example 3A.

Table 3 below shows the results of the three experiments Example 3A, 3B, and 3C as well as the calculated total CO₂ conversions, i.e. calculated form the CO₂ outlet concentration of Example 3B and the inlet CO₂ concentration of Example 3A, and similarly for Example 3C and Example 3A, simulating the expected CO₂ conversion in a two-stage reactor with intermediate H₂O removal as per FIG. 1 with multi-tubular reactor 2a) of FIG. 2.

The row “3A+3B” in Table 3 demonstrates a high CO₂ conversion of 72% obtainable at a relatively low temperature of 570° C., with the line-up of FIG. 1, whereas a conventional single stage reactor would only achieve 54% CO₂ conversion. Similarly, the row “3B+3C” in Table 3 demonstrates a high CO₂ conversion of 70% obtainable at a relatively low temperature of 570° C., with the line-up of FIG. 1, whereas a conventional single stage reactor would only achieve 54% CO₂ conversion.

TABLE 3

| | | | | | | | CO₂ thermodynamic | |
|---|---|---|---|---|---|---|---|---|
| | | | | | | CO₂ | equilibrium | Methane |
| | T | GHSV | H₂/CO₂ | CO/H₂ | CO/H₂ | conversion | conversion [%] | selectivity |
| Example | [° C.] | [Nl/l · h] | inlet | inlet | outlet | [%] | (excl. methane) | [%] |
| Ex. 3A | 570 | 11323 | 2.5 | 0 | 0.28 | 54 | 54 | <0.1 |
| Ex. 3B | 570 | 9766 | 3.6 | 0.36 | 0.53 | 38 | 39 | <0.2 |
| Ex. 3C | 570 | 9200 | 3.6 | 0.25 | 0.42 | 44 | 44 | <0.3 |
| 3A + 3B | 570 | N/A | 2.5 | 0 | 0.53 | 72 | 73 | <0.2 |
| 3A + 3C | 570 | N/A | 2.5 | 0 | 0.42 | 70 | 70 | <0.3 |

### DISCUSSION

As can be seen from the above Examples, the method according to the present invention allows for an effective way of producing syngas using a catalytic RWGS reaction, whilst maintaining the temperature in the RWGS reactors below 700° C. and whilst still achieving desirable CO₂ conversions (of above 65%), with just 2 RGWS stages. When more RWGS stages are used, CO₂ conversions of 75% or more (even above 80%) can be achieved.

The person skilled in the art will readily understand that many modifications may be made without departing from the scope of the invention.

1. A method for producing syngas using a catalytic reverse water gas shift (RWGS) reaction, the method at least comprising the steps of:
a) providing a feed stream comprising at least hydrogen (H₂) and carbon dioxide (CO₂);
b) heating the feed stream provided in step a) in a first heat exchanger thereby obtaining a first heated feed stream;
c) introducing the first heated feed stream into a first RWGS reactor and subjecting it to a first catalytic RWGS reaction, thereby obtaining a first syngas containing stream;
d) removing the first syngas containing stream obtained in step c) from the first RWGS reactor;
e) cooling the first syngas containing stream removed from the first RWGS reactor in step d) in the first heat exchanger against the feed stream provided in step a), thereby obtaining a first cooled syngas stream;
f) separating the first cooled syngas stream obtained in step e) in a first gas/liquid separator thereby obtaining a water-enriched stream and a water-depleted syngas stream;
g) heating the water-depleted syngas stream obtained in step f) in a second heat exchanger thereby obtaining a heated water-depleted syngas stream;
h) introducing the heated water-depleted syngas stream obtained in step g) into a second RWGS reactor and subjecting it to a second catalytic RWGS reaction, thereby obtaining a second syngas containing stream;
i) removing the second syngas containing stream obtained in step h) from the second RWGS reactor; and
j) cooling the second syngas containing stream removed from the second RWGS reactor in step i) in the second heat exchanger against the water-depleted syngas stream obtained in step f), thereby obtaining a cooled syngas product stream.

2. The method according to claim 1, wherein the temperature of the first catalytic RWGS reaction in step c) is kept below 700° C.

3. The method according to claim 1, wherein at least one of the first and the second RWGS reactors contains two or more catalyst beds with additional intermediate heating between the two or more catalyst beds.

4. The method according to claim 1, wherein at least one of the first and the second RWGS reactors comprises a multi-tubular reactor heated by molten salt circulating around the tubes of the multi-tubular reactor.

5. The method according to claim 1, wherein the first syngas containing stream comprises at most 1.0 vol. % methane (CH₄).

6. The method according to claim 1, wherein the temperature of the second catalytic RWGS reaction in step h) is kept below 700° C.

7. The method according to claim 1, wherein the method further comprises the step of separating the cooled syngas product stream obtained in step j) in a second gas/liquid separator, thereby obtaining a water-enriched stream and a water-depleted syngas product stream.

8. An apparatus (1) suitable for performing the method for producing syngas according to claim 1, the apparatus at least comprising:
a first heat exchanger for heat exchanging the feed stream against the first syngas containing stream removed from the first RWGS reactor, to obtain a first heated feed stream and a first cooled syngas stream;
a first RWGS reactor to obtain a first syngas containing stream;
a first gas/liquid separator for separating the first cooled syngas stream to obtain a water-enriched stream and a water-depleted syngas stream;
a second heat exchanger for heat exchanging the water-depleted syngas and the second syngas containing stream removed from the second RWGS reactor, to obtain a heated water-depleted syngas stream and a cooled syngas product stream;
a second RWGS reactor to obtain a second syngas containing stream.

9. The apparatus according to claim 8, wherein at least one of the first and the second RWGS reactors contains two or more catalyst beds with additional intermediate heating between the two or more catalyst beds.

10. The apparatus according to claim 8, further comprising a second gas/liquid separator for separating the cooled syngas product stream to obtain a water-enriched stream and a water-depleted syngas product stream.

11. The method according to claim 1, wherein the temperature of the first catalytic RWGS reaction in step c) is kept below 600° C.

12. The method according to claim 1, wherein the first syngas containing stream comprises at most 0.1 vol. % methane.

13. The method according to claim 1, wherein the temperature of the second catalytic RWGS reaction in step h) is kept below 700° C.
